(19) United States
(12) Patent Application Publication
(10) Pub. No.: US 2012/0219824 A1
(43) Pub. Date: Aug. 30, 2012

(54) ATOMIC LAYER DEPOSITION OF SUPER-CONDUCTING NIOBIUM SILICIDE

(75) Inventors: Thomas Prolier, Woodridge, IL (US); Jeffrey Elam, Elmhurst, IL (US); Jeffrey Klug, Westmont, IL (US); Michael J. Pellin, Naperville, IL (US)

(73) Assignee: UChicago Argonne LLC

(21) Appl. No.: 13/036,952

(22) Filed: Feb. 28, 2011

(51) Int. Cl. B05D 5/12; B32B 15/00

(52) U.S. Cl. 428/662; 427/62; 428/544

(57) ABSTRACT

A method of preparing a superconducting thin film of niobium silicide using atomic layer deposition (ALD) where the superconducting critical temperature of the film is controllable by modulating the thickness of the thin film. The film is formed by exposing a substrate within an ALD reactor to alternating exposures of a niobium halide (NbQₓ) and a reducing precursor, for example, disilane (Si₂H₆) or silane (SiH₄). A number of ALD cycles are performed to obtain the film thickness and establish the desired superconducting critical temperature between 0.4 K and 3.1 K.

### GOVERNMENT INTEREST

The United States Government has rights in this invention pursuant to Contract No. DE-AC02-06CH11357 between the United States Government and the UChicago Argonne, LLC, representing Argonne National Laboratory.

### FIELD OF THE INVENTION

The present invention is directed to superconducting thin film coatings. More particularly, the invention is directed to superconducting niobium silicide thin films and methods of preparing such films using atomic layer deposition.

### BACKGROUND

This section is intended to provide a background or context to the invention that is, inter alia, recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Niobium silicide based alloys have a wide range of application. For example the materials may be used in tunnel barriers for Josephson junctions, as a superconductor for particle detection (bolometers), and low friction and high temperature corrosion resistant coatings for various engine components. NbₓSi₁₋ₓ compounds of various compositions can be deposited using a variety of methods including electron gun evaporation, RF magnetron sputtering (amorphous), explosive or arc melting and chill-casting (NbSi₃), chemical vapor deposition (NbSi₂ and Nb₅Si₃), direct laser fabrication or ion-induced formation.

Low temperature, amorphous superconductors such as NbSi are of particular interest for bolometry, where homogeneous thin superconducting films are used to detect particles. Bolometers operate at low temperature to increase the signal to noise ratio and should be near the superconducting—normal metal transition for optimal sensitivity. These conditions narrow the field of available materials to low temperature superconductors with homogeneous properties and thickness. The current methods employed to make bolometers rely on multiple step, line of sight deposition techniques, which generally limits the complexity of the devices, to build low critical temperature (T_{c}) superconducting film structures.

### SUMMARY

This invention relates to thin superconducting films comprising transition metals and silicon. In one embodiment, the thin superconducting film comprises niobium silicide (NbSi). The superconducting critical temperature of the film is tunable by providing a predetermined film thickness of the material. For example, the superconducting critical temperature of the NbSi film is tunable between 0.4 K and 3.1 K by modulating the thickness of the thin film from about 5.2 nm to 45 nm or greater. The invention further relates to methods of synthesizing the thin films, including NbSi thin films, using atomic layer deposition (ALD). ALD permits conformal and uniform coating of arbitrary surfaces with a desired composition one atomic monolayer per ALD cycle. Because ALD is not a line of sight deposition technique, NbSi films may be prepared on complex surfaces with precise control over film thickness, expanding the range of applications beyond those available using conventional deposition techniques such as reaction ion sputtering (DC or AC), CVD, and MOCVD.

ALD may be used to coat various substrates with NbSi films, other metal silicide films, and mixed alloy silicide films, including high-aspect ratio substrates, i.e., substrates with an aspect ratio between about 1:10 and 1:1,000. Films prepared by ALD have a substantially uniform thickness. In this respect, superconducting films made by ALD can provide complete freedom of geometry and thus applications. For example, ALD may used to coat/build bolometers, superconducting RF cavities, superconducting wires, tunnel junctions for Josephson junction based devices with NbSi films. The growth of thin and superconducting films on arbitrary, complex-shaped substrates could be used in preparing for 3-D bolometers or other superconductor-based applications.

In one embodiment, a method of forming on a substrate a niobium silicide (NbSi) superconducting film with a tunable superconducting critical temperature by performing a plurality of atomic layer deposition (ALD) cycles within an ALD reactor is provided. In the method, each ALD cycle comprises establishing a deposition temperature within the ALD reactor, exposing the substrate within the deposition chamber to a niobium halide precursor, purging the deposition chamber with an inert purge gas, exposing the substrate to a reducing precursor containing silicon to form a monolayer of NbSi over the substrate, and purging the deposition chamber with the inert purge gas. In various embodiments, the reducing precursor is selected from the group consisting of Si₂H₆ and SiH₄. The superconducting critical temperature of the film is established between about 0.4 K and about 3.1 K by performing a number of the ALD cycles to obtain a predetermined thickness of the NbSi film on the substrate.

In another embodiment, a method of preparing a superconducting film having a tunable superconducting critical temperature using atomic layer deposition (ALD), comprises providing a metal halide precursor capable of forming a superconducting film on a substrate, and providing a reducing precursor comprising silicon. The method further comprises forming at least one superconducting film on the substrate by performing a number of ALD cycles at a deposition temperature to obtain the at least one superconducting film that comprises the transition metal and silicon and which is characterized by a film thickness. Each ALD cycle comprises exposing the substrate to the metal halide precursor for a first predetermined period, exposing the substrate to the reducing precursor for a second predetermined period, and purging the ALD reactor after each of the metal halide precursor and reducing precursor exposures. The superconducting critical temperature of the at least one superconducting film is selectively tunable between about 0.4 K and about 3.1 K by modulating the film thickness of the at least one superconducting film.

In still another embodiment, a film prepared by atomic layer deposition (ALD) having a tunable superconducting critical temperature, comprises a metallic thin film of niobium silicide (NbSi) characterized by an amorphous structure and a density of about 6.65 g/cm³. The metallic thin film is further defined by a substantially uniform film thickness and a superconducting critical temperature selectively tunable between about 0.4 K and about 3.1 K. The superconducting critical temperature is selected by establishing the substantially uniform film thickness between about 5.2 nm and about 45 nm.

These and other objects, advantages, and features of the invention, together with the organization and manner of operation therefore, will become apparent from the following detailed description when taken in conjunction with the accompanying drawings, wherein like elements have like numerals throughout the several drawings described below.

### BRIEF DESCRIPTION OF THE DRAWINGS

FIG. 1 is a plot from a quadrupole mass spectrometer (QMS) for m=85 to 104 versus time during alternating atomic layer deposition (ALD) exposures to a NbF₅ precursor (dotted line) and a Si₂H₆ precursor (dashed line) at a deposition temperature of 200° C. using an ALD timing sequence 2-10-1-10 to for a NbSi thin film according to an embodiment of the present invention;

FIG. 2A is a plot of the quartz crystal microbalance (QCM) signal versus time during the alternating exposures to NbF₅ and Si₂H₆ at 200° C. using the timing sequence 2-10-1-10; FIG. 2B is an expanded view showing correlation between the QCM signal (solid line) and exposure to NbF₅ (dotted line) and Si₂H₆ (dashed line), where mass gain after one Si₂H₆ pulse is represented by Δm₁ and for a complete NbSi cycle by Δm₂;

FIGS. 3A and 3B are plots showing the growth rate of a NbSi thin film for various ALD exposure times of the NbF₅ precursor (FIG. 3A) utilizing an ALD timing sequence of x-10-1-10 at 200° C. and the Si₂H₆ precursor (FIG. 3B) utilizing an ALD timing sequence of 2-10-x-10;

FIG. 4A is a plot of the NbSi growth rate and roughness for various deposition temperatures measured by (X-ray reflectivity) XRR for NbSi thin films deposited on Si(100) after 100 ALD cycles using a timing sequence of 2-10-2-10; FIG. 4B is plot of the film density measured by XRR (squares) and (Rutherford backscattering spectrometry) RBS (stars) and electrical resistivity for the films of FIG. 4A;

FIG. 5A represents the composition of NbSi films measured by Rutherford back scattering (RBS); FIG. 5B shows XPS spectra of Si 2p peak before (dash-dotted line) and after (solid line) Ar sputtering; FIG. 5C shows XPS spectra of the Nb 3d's peaks before (dash-dotted line) and after (solid line) Ar sputtering; and FIG. 5D shows binding energy of the Nb and Si peaks as a function of the growth temperature of films grown on Si(100) with 100 cycles using the timing sequence 2-10-1-10;

FIGS. 6A-6D are scanning electron microscope (SEM) pictures of a NbSi thin film grown on Si(100) at 200° C. using the pulsing sequence 2-10-1-10 and 300 ALD cycles (FIG. 6A-6C) with FIGS. 6B and 6C showing detailed views of portions of the film of FIG. 6A; and on a trenched Si wafer (FIG. 6D);

FIG. 7 is a plot of the resistance (ohms) versus temperature of a NbSi film prepared by ALD;

FIG. 8 shows a plot of the magnetization M versus temperature as measured by SQUID magnetometry on NbSi films grown on Si(100) using the timing sequence 2-10-1-10 showing as grown films, dashed lines corresponding to post annealed films in Ar, and dotted lines corresponding to post annealed films in N₂, with annealing conducted at temperatures: of 400° C. and 600° C. as shown; and

FIG. 9A is a plot of superconducting critical temperature in relation to film thickness for a NbSi film prepared by ALD at a deposition temperature of 225° C.; and FIG. 9B is a plot of film resistivity (μΩ.cm) versus film thickness for the films of FIG. 9A.

### DETAILED DESCRIPTION OF EMBODIMENTS

According to various embodiments of the present invention, atomic layer deposition (ALD) is used to synthesize a metal silicide (MSiₓ) on a substrate. For example, ALD may be used to synthesize niobium silicide (NbSi), tungsten silicide (WSi₂), other transition metal silicides, and combinations of metal silicide thin films on various substrate materials and configurations. In the case of NbSi, the ALD process utilizes alternating pulses within an ALD reactor of a niobium precursor and a silicon based precursor. In a particular embodiment, the niobium precursor comprises a niobium halide, for example, niobium fluoride (NbF₅) and tungsten hexafluoride (WF₆). In particular embodiments, the silicon based precursor comprises disilane (Si₂H₆) or silane (SiH₄). The ALD reactor is substantially purged by a pulse of inert purge gas such as N₂ or Ar following each pulse of the niobium precursor and the silicon based precursor. ALD is conducted a deposition temperature to achieve growth of the metal silicide. For NbSi, the deposition temperature ranges between about 150° C. to 450° C. In various embodiments, self-limiting growth of NbSi is achieved at deposition temperatures between about 150° C. to 300° C. The resulting homogeneous NbSi film is a superconducting material with a critical temperature that is selectively controllable by controlling the film thickness, which is established by the number of ALD cycles that are performed.

In various embodiments, atomic layer deposition was utilized to synthesize niobium NbSi films with a 1:1 stoichiometry on oxide-free seed films. The process can utilize relative low precursor evaporation temperatures for the metal precursors (65° C. for NbF₅). Self-limiting reaction yields a NbSi growth rate of 4.5 Å/cycle. Across the range of deposition temperatures (150° C. to 300° C.) and ALD timing sequences the films are substantially pure and consist essentially of NbSi (i.e., no detectable fluorine impurities). The films are amorphous with a density of 6.65 g/cm³ and metallic with a resistivity ρ=150 μΩ.cm at 300 K for films thicker than 35 nm. The ALD growth rate levels off for growth temperatures higher than 300° C., indicative of the beginning of a chemical vapor deposition (CVD) regime. The electronic properties of the films, measured to 1.2 K, reveal a superconducting transition temperature, or superconducting critical temperature, of T_{c}=3.1 K.

ALD is a self-limited synthesis technique that can coat arbitrary complex shape surfaces with uniform thickness and composition down to the atomic level. As such, in various embodiments, ALD can synthesize conformal, uniform films from about 2 nm to several microns. In this respect Superconducting films made by ALD can be used to coat/build various structures with freedom of geometry, including bolometers, superconducting RF cavities, superconducting wires, tunnel junctions for Josephson junction based devices.

A typical ALD scheme may be utilized for forming the thin film metal silicides. Namely, in an ALD reactor a substrate is exposed to alternating pulses of a metal precursor and a reducing precursor for predetermined periods, thus forming, by self-limiting reaction, the resistive metal silicide film on the substrate. The ALD reactor is substantially purged following each precursor pulse by a purge gas such as Ar or N₂. This typical ALD operating cycle can be described as A/P/B/P, where A represents the metal precursor, B represents the reducing precursor, and P represents the purge gas. In a particular embodiment, A comprises NbF₅ and B comprises Si₂H₆. The cycle may also be represented by a timing sequence that provides the ALD pulse durations (in seconds) for the reactants and purge gases, e.g., 2-10-1-10. The timing of each of the exposures may be adjusted to obtain saturation such that a continuous layer is formed on the substrate for each ALD cycle. In various embodiments, the ALD cycle may be expanded to form mixed alloy films by utilizing multiple ALD cycles comprising: A/P/B/P |C/P/D/P, where the additional reactant C represents one or more additional metal precursors and D represents a reducing precursor which may be the same or different from B. The ratio of A/P/B/P to C/P/D/P may be varied to control the alloy composition of the film. The thickness of the film is controlled by the number of ALD cycles performed.

Various thin superconducting films were prepared by ALD utilizing a viscous flow ALD reactor. The reactor includes a two inch Inconel 600 tube deposition zone. The reactor temperature, i.e., deposition temperature, is controlled by an external resistive three-zone system and measured in nine locations along the deposition chamber to insure temperature homogeneity. Ultra pure Nitrogen (99.999%) further purified by an oxygen filter was used as a carrier and purging gas, the total flow of N₂ was maintained at 360 sccm by mass flow controllers and the average pressure inside the ALD apparatus was ˜1.3 Torr. The reactor was also equipped with differentially pumped quadrupole mass spectrometer (QMS) (Stanford research Systems, Model RGA300) located downstream from the sample location and separated from the reactor by a 35-μm pin-hole. The quartz crystal microbalance (QCM) used is a Maxtek Model BSH-150 sensor head accommodating a single side polished quartz crystal sensor (Tangidyne/VB) and interfaced to the computer via a Maxtek Model TM400 film thickness monitor.

During the NbSi depositions, the NbF₅ (98%, Sigma-Aldrich) precursor was held at 65° C. in a stainless steel bubbler while disilane or silane (99.998% Sigma-Adrich) was maintained at room temperature in their respective original stainless steel lecture bottles. Computer-controlled actuated pneumatic valves operate the ALD pulsing sequence. In various embodiments, the ALD cycle consisted of an exposure of the substrate to the metal precursor (NbF₅), a N₂ purge, a exposure to the reducer (Si₂H₆), and a second N₂ purge.

The resulting films prepared by ALD were measured by X-ray photoemission spectroscopy (XPS, Perkin Elmer Φ500) and Rutherford back scattering (RBS). The film thickness and density were determined by X-ray reflectivity (Expert-Pro MRD, Philips) using Cu Kα X-rays and structural analysis was performed by X-ray diffraction (Rigaku Model ATXG rotating anode using Cu Kα x-rays). Scanning electron microscope (SEM) images of the films were also obtained (Hitachi Model S4700). The electronic and superconducting film properties were measured by a four point probe method at room temperature and with a superconducting quantum interference device (SQUID) down to a temperature of 1.2 K under an external field of 10 mGauss.

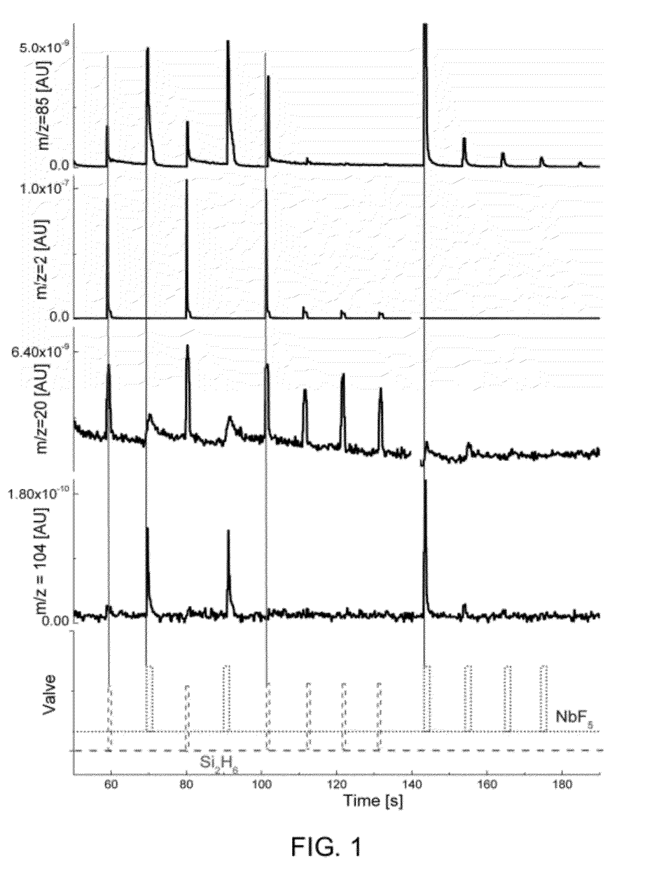

QCM and QMS measurements were utilized to ascertain the reaction mechanism for the ALD process. These measurements were performed at a deposition temperature of 200° C. using an ALD pulse sequence: 2-10-1-10 seconds. Representative QMS data recorded during a deposition of NbSi using NbF₅ and Si₂H₆ precursors are shown in FIG. 1 for m=104, 85, 20, and 2. A peak at m=104 appears during the NbF₅ half reaction but not during the Si₂H₆ half-reaction. However, if no Si₂H₆ is pulsed the m=104 peak disappears as shown by the final five ALD pulses in FIG. 1. By collecting QMS data over the mass range of 2-110 amu, it was determined that the NbF₅ reaction yields the following products (and relative abundance): m=104 (1.5), 87 (5.5), 86 (12), 85 (100), 47 (10), 33 (7). This mass pattern matches closely the fragmentation pattern for silicon tetra-fluoride (SiF₄). A similar trend was found for m=20 that corresponds to hydrofluoric acid (HF). The measurements demonstrate that SiF₄ and HF are the only gas phase products during the half reaction of NbF₅. In the same QMS measurement run, ALD of tungsten, using WF₆, was also performed. The tungsten deposition resulted in a QMS peak at m=20 with an intensity approximately five times smaller than ALD NbSi using NbF₅. It may be deduced that the amount of HF reaction product is approximately 5HF.

A sharp spike at mass m=2 is coincident with Si₂H₆ exposure, followed by a smaller plateau that persist as long as Si₂H₆ is supplied, as illustrated by the first three pulses of FIG. 1. However, when only Si₂H₆ is pulsed, the sharp spike is absent, as shown by ALD pulses 5 through 9 of FIG. 1. Simultaneously, a series of peaks also appear at m=47(30), 66(15), 67(65.8), 85(100), 86 (10) during the Si₂H₆ pulses but no peaks occur at m=104 or m=49, which correspond to the cracking pattern of trifluorosilane (SiHF₃). These peaks are also absent when only Si₂H₆ is pulsed. It can therefore be concluded that H₂ and SiHF₃ are the reaction products of the Si₂H₆ half-reaction.

Similarly, the W ALD peak intensity at m=85 and at m=104 are approximately twice as large as the intensities during NbSi deposition. Therefore, the relative amount of SiHF₃ and SiF₄ reaction products should be about half as much for NbSi deposition relative to W deposition. It is also worth noting that the peak intensity ratio m(85)_{NbF5}/m(85)_{si2H6}=3. Presuming that the ionization efficiency is the same for SiF₄ and SiHF₃, it follows that about three times more SiF₄ than SiHF₃ will be produced during ALD of NbSi.

Taking into account the QMS data, a preliminary reaction scheme during the ALD process can be generalized as follow:

NbFₐ*+b Si₂H₆→NbSi_{c}H_{d}Fₑ*+ƒSiHF₃+g H₂ (1)

NbSi_{c}H_{d}Fₑ*+h NbF₅→(NbSi)ᵢNbFₐ*+j SiF₄+k HF (2)

In Equations 1 and 2 the surface species are designated with an asterisk and it is assumed that NbFₐ* is the surface species present after the NbF₅ pulse. This is a reasonable assumption considering that the growth mechanism studies for Mo and W metal also revealed the presence of MoF₄* and WF₄* as surface species after pulses of the halides MoF₆ and WF₆, respectively. In Equation 2, the final film composition after one ALD cycle is NbSi with a ratio of 1:1. This can be deduced from RBS measurement done on niobium silicide films grown under the same conditions on quartz or on silicon substrates. By equilibrating each half-reaction, posing e−α=δ, k≈5, and j≈1 and f≈⅓, a set of seven equations and eight unknowns are obtained. The last equation, necessary to solve the reaction scheme, is given by the QCM data analysis.

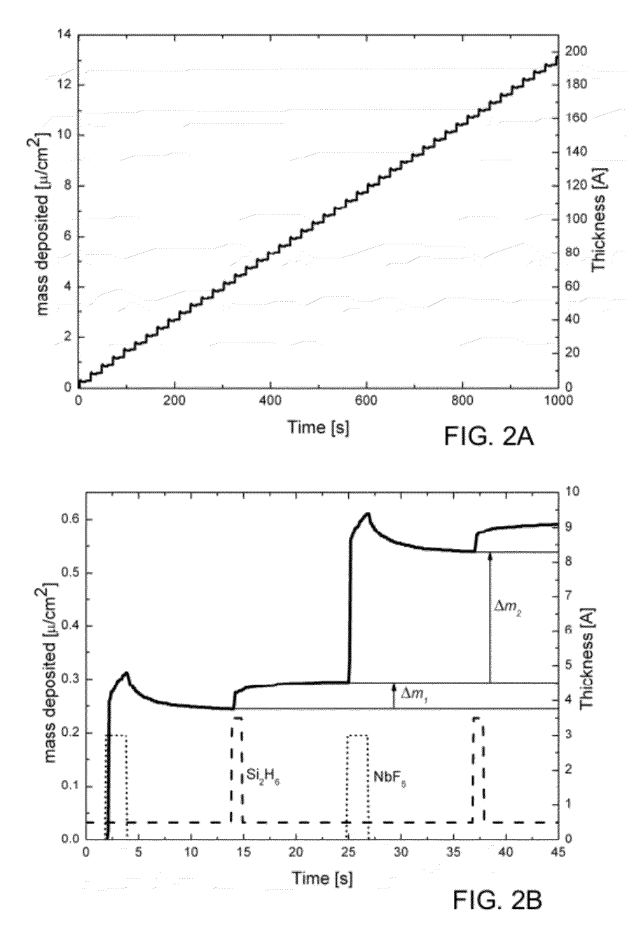

FIG. 2A shows the QCM data recorded simultaneously with the QMS measurements of FIG. 1 and demonstrates that alternating NbF₅ and Si₂H₆ exposures result in a linear mass increase over time. The slope yields a net mass change of 300 ng/cm²/cycle. The XRR measurements of the NbSi film density and thickness grown on quartz and silicon (100) substrates under the same conditions give a density of 6.65 g/cm³ at 200° C. and a growth rate (GR) of 4.5 Å/cycle. The growth rate measured by QCM and XRR are identical. The film properties were found to be homogeneous upstream and downstream of the QCM position in the ALD reactor.

FIG. 2B is an zoomed in view of the QCM data of FIG. 2A for two ALD cycles. There is an abrupt mass increase, Δm₂, during the NbF₅ pulse and a transient mass decrease during the subsequent 10 second purge, followed by a smaller mass increase, Δm₁, during the Si₂H₆ exposure. This mass loss during the purge following the NbF₅ pulse may be attributed to the reaction of NbF₅ with surface species, indicative of an etching effect. The final equation is obtained using the mass gain ratio R=Δm₂/Δm₁=4, Equations 1 and 2, and the atomic masses Δm₂=93h+19δ-28 (c-i)-d and Δm₁=28c-19δ+d. Accordingly, the reaction Equations (1) and (2) transform into:

NbFₓ*+11/6 Si₂H₆→NbSi₃H₄Fₓ₋₂*+⅔SiHF₃+19/6H₂ (3)

NbSi₃H₄Fₓ₋₂*+2NbF₅→(NbSi)²NbFₓ*+SiF₄+4HF (4)

The Assuming x=3, providing NbF₃* as the surface species, the composition becomes NbSi₃H₄F. This is identical to the reaction product obtained during the W deposition, namely WSi₃H₄F, and described as WSiHFSiH₃*. For x=4, it could reasonably be assumed that NbSi₃H₄F₂* can be written as either (NbSi)(SiHF₂)*(SiH₃)* or (NbSi)(SiH₂F)₂*.

The NbSi films were prepared by ALD on Si (100), fused quartz, and Sapphire substrates. NbSi films generally grow at deposition temperatures of at least 200° C. Above 200° C. the NbSi films begin growing on any substrate due to the partial catalytic thermal decomposition of disilane into Si that has been deposited onto the substrate surface. At a deposition temperature of 225° C. the nucleation delay is about 5 cycles. The films grow immediately for deposition temperatures above 250° C. However, NbSi films may also be grown by ALD at a deposition temperature of less than 200° C. The controlled, i.e., self-limited, ALD growth regime for NbSi ranges between 150° C. to 300° C., where the growth rate is 4.5 Å/cycle and the density of the resulting NbSi film is 6.65 g/cm³. The resulting films were observed to be silver in color.

Growth of metal silicide films synthesized from halides (e.g., WF₆ or NbF₅) and reducers (e.g., Si₂H₆, SiF₄, TMA, NH₃) occurs on various films such as films prepared by ALD, including W, metal carbides (e.g., NbC), metal nitrides (e.g., NbN), and metal. Deposition temperatures between 150° C. to 200° C. generally produces NbSi film growth only on tungsten (W) and carbides (e.g, NbC), nitrides (e.g., NbN), carbide nitrides (e.g., NbCN). While at these deposition temperatures, no growth is generally observed on sputtered Au, AlO₃, Nb₂O₅, PtOₓ, FeOₓ, or NbTi. From 225° C. to 300° C. NbSi films grow on any substrate and the nucleation cycles decrease gradually, indicative of a starting CVD process, the density is 6.65 g/cm³ and the composition is NbSi. From 300° C. to 450° C., the growth rate is not controlled and increases up to 8.6 A/cycle, however the density and chemical composition remain unaltered.

Without limiting the scope of the present invention, the observed growth characteristics suggest that the growth of NbSi may be inhibited by the presence of an oxide layer on the substrate. The QCM analysis reveals that ALD of Nb₂O₅ utilizing NbF₅+H₂O or H₂O₂ as precursors grows well, with a growth rate of 2 and 2.3 Å/cycles, respectively. However, subsequent replacement of H₂O by Si₂H₆ stops abruptly the film growth after just one exposure of Si₂H₆ following the NbF₅ pulse. No growth was noticed during the next hundred cycles of NbF₅+Si₂H₆, however after only 2-3 pulsing sequence of NbF₅+H₂O, the Nb₂O₅ growth resumes. It may be postulated that the etching of Si according to Equation 4 is necessary to the growth of NbSi and it is inhibited due to the formation of a stable oxide, NbₓSi_{y}O_{z}.

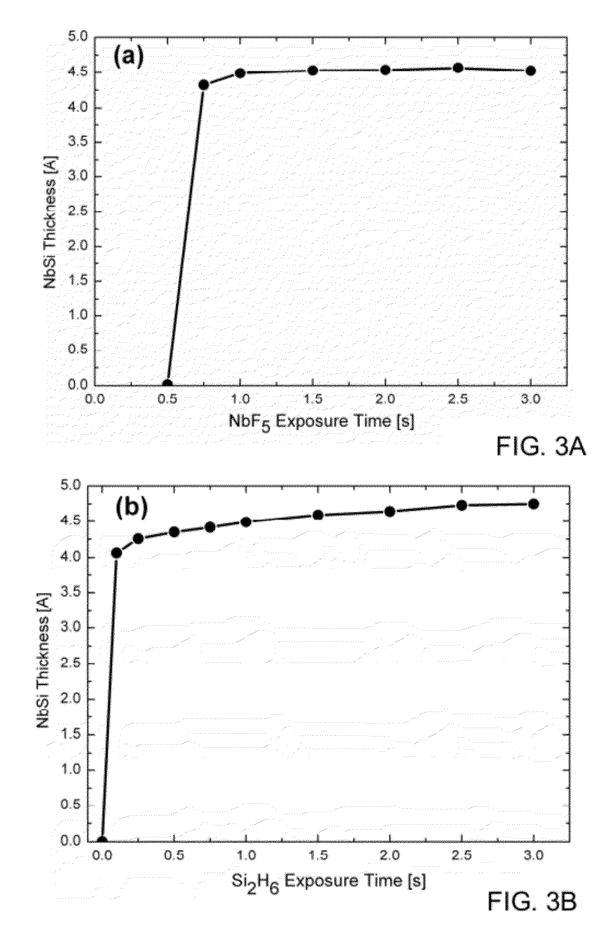

NbSi films were grown on a multilayer seed layer of W over Al₂O₃, utilizing 15 ALD cycles of W and 100 ALD cycles of NbSi using NbF₅ and H₂Si₆. FIG. 3A shows the results of uptake measurements made at a deposition temperature of 200° C. while varying the exposure time of NbF₅ using the timing sequence x-10-1-10. FIG. 3A demonstrates the self-limiting behavior for ALD of NbF₅ for exposure times of about 1 second. FIG. 3B shows a similar graph demonstrating the effect of increasing Si₂H₆ exposure time using the timing sequence 2-010-x-10. FIG. 3B reveals an abrupt jump of the growth rate after a exposure of 0.25 seconds that increases slowly for longer exposure times with a slope of about 0.15 Å/second. The increasing slope for Si₂H₆ exposure time is indicative of a moderate chemical vapor deposition (CVD) effect that is characteristic of Si₂H₆ when used as an ALD reducing precursor. For NbSi films the timing sequence 2-10-1-10 provides uniform film properties along all sample locations within the reactor over a 20 cm length.

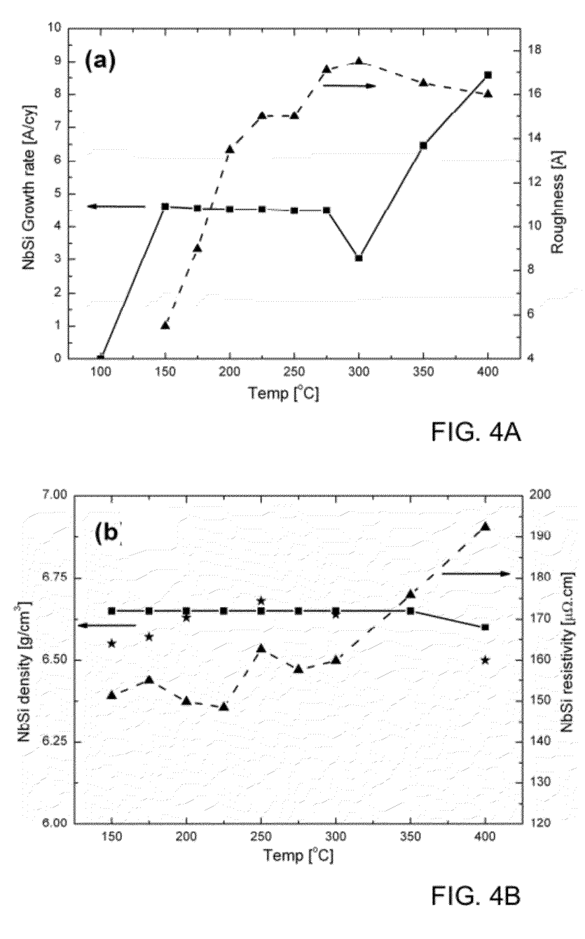

The effect of the deposition temperature on the NbSi growth rate and film roughness is shown in FIG. 4A. No growth was observed for a deposition temperature of 100° C., whereas the growth rate is constant, GR=4.5 Å/cycles, over the deposition temperature range of about 150° C. to about 300° C. Above 300° C. the CVD regime dominates and the deposition becomes non-uniform along the length of the reactor. For ALD films with the same number of cycles, the roughness begins increasing as soon as growth occurs from 0.4 nm at 150° C. to 1.4 nm at about 200-225° C. and saturates at temperatures greater than 225° C.

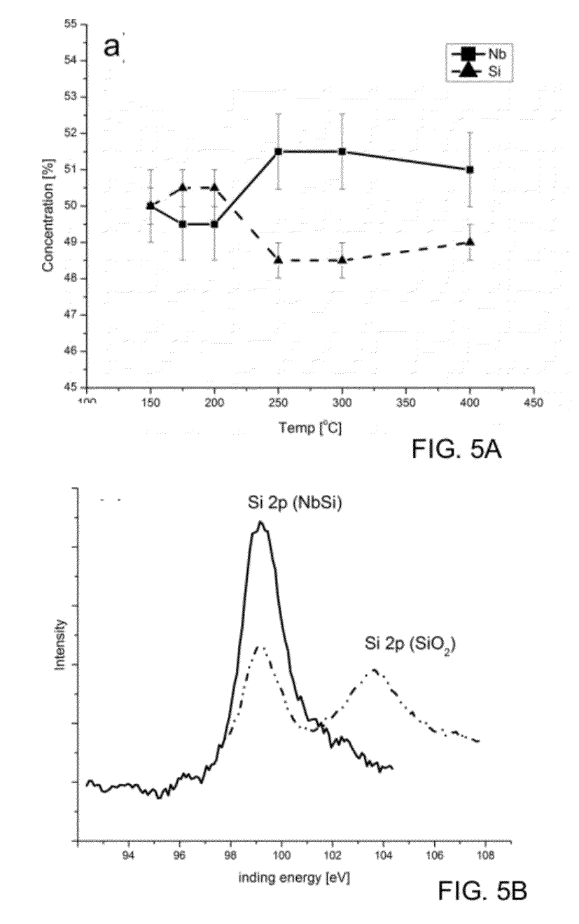

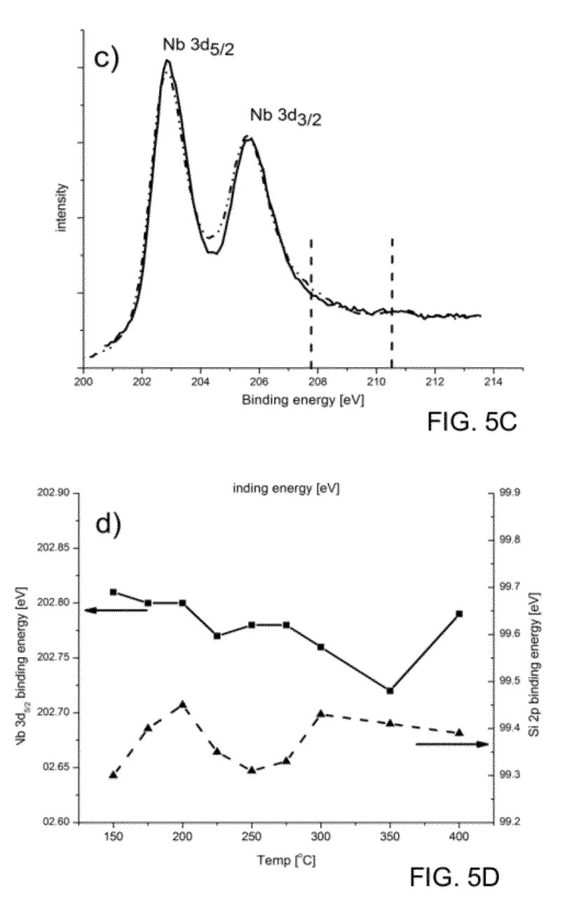

FIG. 4B shows the resistivity value of the NbSi films as a function of the deposition temperature. FIG. 4B also shows the density of the resulting NbSi film, which for all temperatures, the chemical composition of the films was identical with a ratio of Nb/Si=1 and a density of 6.65 g/cm³, which is consistent with the XRR analysis. This last result suggests that the NbF₅ etches the silicon films deposited during the disilane pulse, following similar chemical reaction as in Equations 3 and 4 when the CVD regime starts dominating above 300° C. It is nonetheless unexpected that a uniform stoichiometry (1:1) on the 1 μm² RBS sampling zone dominates in the films at all temperature. With reference to FIG. 5A and 5B, RBS and XPS measurements, respectively, performed on the films reveal the presence of native oxides SiO₂ but almost no Nb₂O₅ on the surface of the films. The same trend is observed on the film series grown at different temperatures and left up to one week in air following deposition. Although Nb readily forms oxide when exposed to air, virtually no Nb₂O₅ was detected. Without limiting the scope of the invention, because the final ALD pulse for the films was disilane, it is possible that a silicon-based passivating layer protected the underlying NbSi from oxidizing.

With reference to FIGS. 5B and 5C, after a mild Ar sputtering the XPS spectrum shows an oxide and fluorine-free NbSi film, in agreement with the RBS measurements. The binding energy for the Nb 3d_{5/2} peak is 202.9 eV (elemental Nb is 202.4 eV) and for the 2p Si peak it is 99.1 eV (elemental Si is 98.5 eV). The shifts in binding energy for both Nb and Si peaks demonstrate that the Nb and silicon atoms are chemically bound together. As shown in FIG. 5D, the binding energy of Nb and Si are constant as a function of the growth temperature. This is indicative of an unvarying chemical environment for both species. Although the Nb:Si ratio extracted from the XPS spectrum is close to 2, different from the RBS measurements shown on the same plot, the apparent discrepancy can be explained by the preferential ion etching of silicon over niobium atoms.

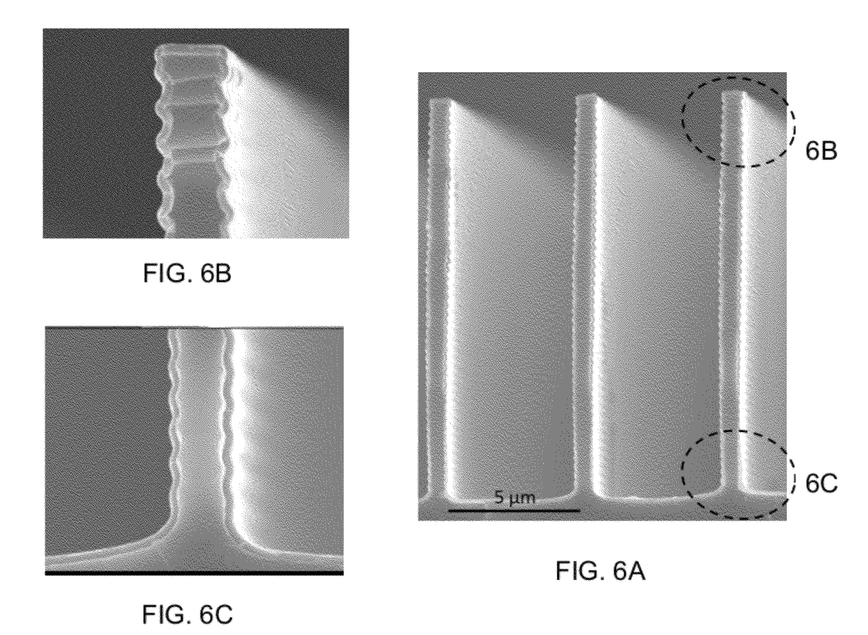

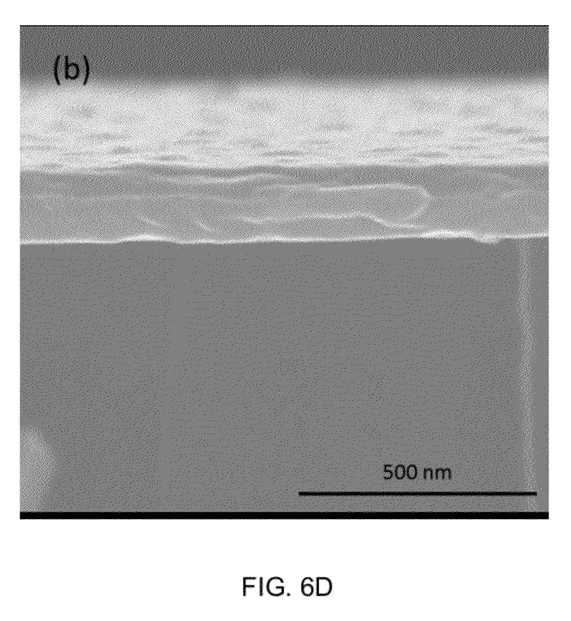

The films prepared by ALD have substantially constant thickness and may be configured to conformally coat the substrate. A wide range of substrates may be utilized, including complex 3-D substrates and high-aspect ratio substrates, i.e., substrates with an aspect ratio between about 1:10 and 1:1,000. For example, FIGS. 6A-6D show SEM images of a NbSi ALD film deposited on a high-aspect ratio trenched silicon wafer. The film was prepared at a deposition temperature below 300° C. The NbSi film is conformally deposited over surfaces of the substrate. The cross-sections (FIGS. 6A-6C) depict a smooth film surface with no obvious grain structures. The resulting NbSi ALD films are super conducting and are characterized by a tunable superconducting critical temperature T_{c}. Specifically, the super conducting critical temperature is controllable by the film thickness, which may be established by the number of ALD cycles performed.

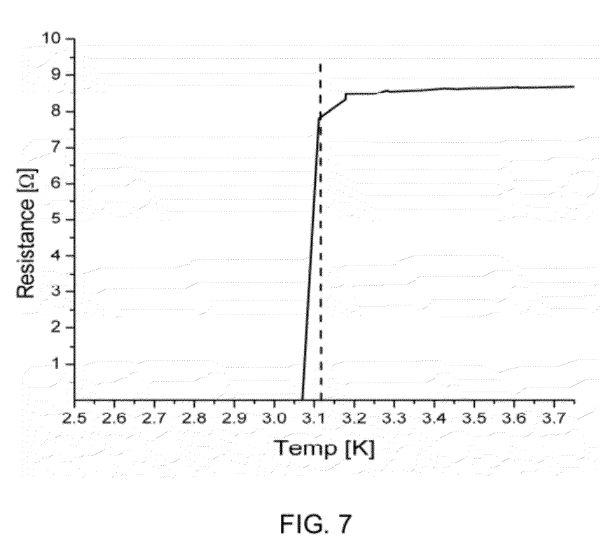

The critical temperature of a NbSi film is depicted in FIG. 7A which shows a plot of the resistance of a NbSi film grown at a deposition temperature of 200° C. with a NbF₅ precursor and a Si₂H₆ precursor. The NbSi film has an abrupt decrease in resistance below the critical temperature T_{c}=3.1 K, characteristic of a superconducting transition. The SQUID determination of T_{c} is more informative than the resistivity measurement, as the width of the transition from the normal to the superconducting state indicates the homogeneity of the superconducting properties throughout the samples. In particular, a sharp transition means a unique T_{c} and therefore a unique alloy stoichiometry. In contrast, resistivity measures the current flowing between 2 or 4 contacts and therefore the percolation path with the highest T_{c}, thus potentially ignoring other phases.

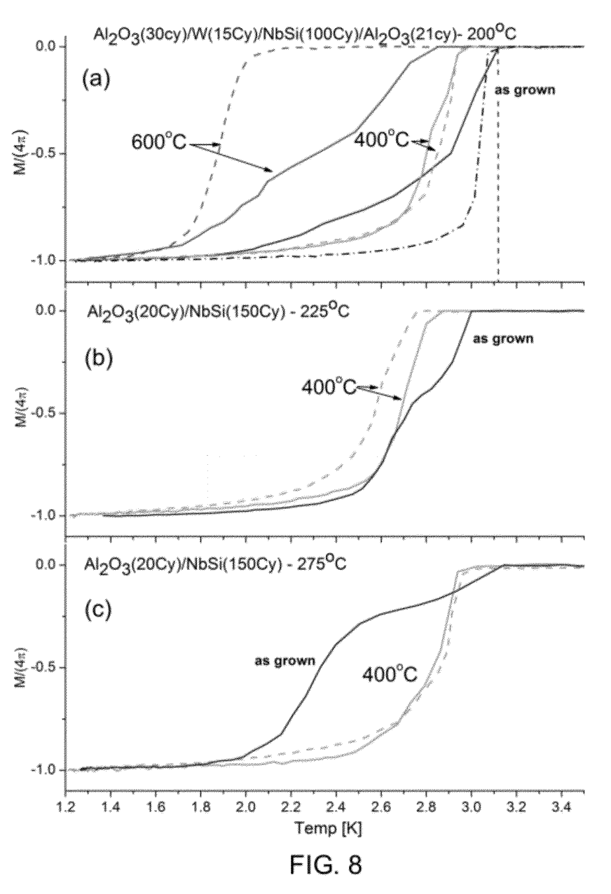

FIG. 8 depicts the NbSi film magnetization M, as measured by SQUID, under an external magnetic field of 10 mGauss applied perpendicular to the sample, as a function of the deposition temperature. The curves labeled “as grown” correspond to measurements done on as grown films, the dashed lines correspond to measurements done after a post anneal of films in Ar and the dotted lines in N₂. The post annealing temperatures: 400° C. or 600° C. are shown next to the corresponding curves. The plots show measurement on the multilayer structure prepared at a deposition temperature of 200° C. comprising a substrate of Si(100), 30 ALD cycles Al₂O₃ over the substrate, 15 ALD cycles of W over the Al₂O₃ layer, and 100 ALD cycles NbSi. The structure is capped with 21 ALD cycles of Al₂O₃. The “as-grown” labeled curve reveals a broad superconducting transition below 3.1 K (indicated by the dashed line), which corresponds to the maximal T_{c} of this film and coincides with the value measured by resistivity. Additional magnetization curves are shown for a NbSi film grown at 225° C. and 275° C. As a comparison the measurements done on NbSi films grown at 400° C. in the CVD regime on 31 ALD cycles of alumina is much sharper. This demonstrates that the NbSi films grown at 200, 225, and 275° C. in the ALD regime have various critical temperatures (T_{c}) across the film, whereas the stoichiometry measured by RBS on the same samples is identical in several spots of 1 μm².

Following deposition, a post annealing of the films in an inert gas at an elevated temperature further improves the superconducting transition width. The annealing process diffuses entrapped hydrogen out of the thin film. The NbSi samples that are depicted in FIG. 8 were annealed in an atmosphere of Ar (dashed lines) or N₂ (solid lines) for 5 hours at 400° C. and at 600° C. and measured again for the superconducting transition by SQUID. The samples annealed in Ar and N₂. After annealing, the same samples possess sharper transitions, indicative of homogeneous superconducting properties. The chemical composition, measured by XPS, shows neither contamination nor diffusion into the NbSi layers after annealing.

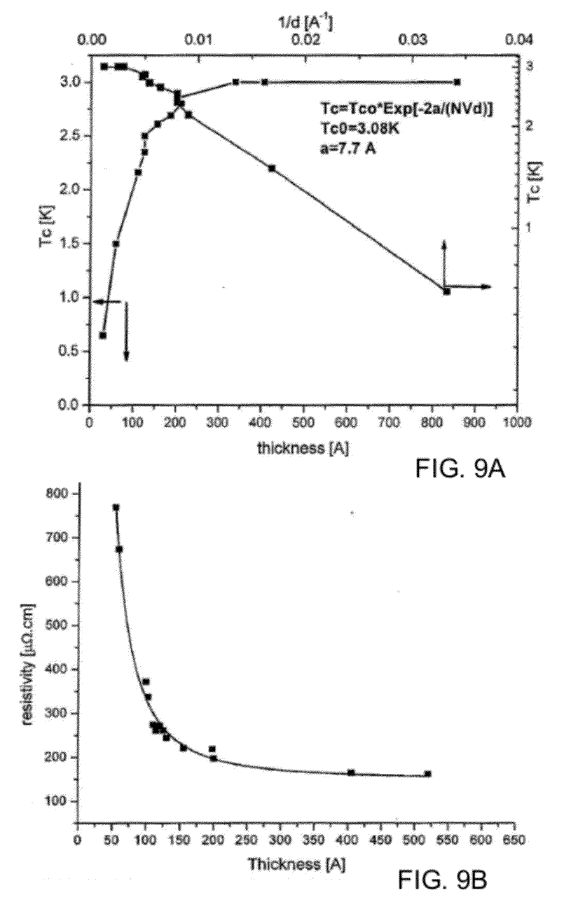

The electrical properties, the superconducting critical temperature Tc and the resistivity of the NbSi films, can be tuned by controlling the film thickness. In various embodiments, the critical temperature of the films can be varied between about 0.4 K and 3.1 K by modulating the film thickness. Film thickness is controlled by selecting the number of ALD cycles in view of the per cycle growth rate (GR), i.e., (film thickness)·(1/GR)=ALD cycles. FIG. 9A, for example, shows the relationship of critical temperature and film thickness for a NbSi ALD film prepared at a deposition temperature of 225° C. As shown in FIG. 9A, the critical temperature Tc has an exponential relationship with the inverse film thickness, which is in good agreement with superconducting film theory. Assuming a superconducting coupling constant (NV) of 0.35, the degraded superconductivity layer thickness of the film (a) is 7.7 Å, which is approximately two atomic layers. This result is indicative of a clean NbSi film and consistent with the presence of a thin oxide layer on top of the film.

The resistivity of the same NbSi film with respect to the film thickness is depicted in FIG. 9B. The resistivity dependence on the film thickness shows an abrupt increase as the film thickness decreases below 10 nm (100 Å). The fit curve reveals a 1/d² behavior of the film resistivity, which may be defined as: r=r_{bulk}+(A/d²), where the bulk resistivity r_{bulk}=150 μΩ.cm and the parameter A=1.2 Ω.Å³. Accordingly, the critical temperature of the thin superconducting NbSi films may be controlled between 0.4 K and 3.1 K by varying the film thickness from about 5.2 nm up to about 45 nm, with the critical temperature increasing with increasing film thickness up to a critical thickness. For example, in the present example, the critical thickness is about 45 nm. Thus, although the thickness of the thin film can be increased beyond the critical thickness, further increasing the thickness does not cause an increase in critical temperature.

A homogeneous superconducting metal silicide film can be prepared on an arbitrary complex shape structures utilizing ALD using the above described processes. The superconducting properties of the film are tuned by controlling the film thickness. In the case of a bolometer, this permits adjustment of the operating temperature of the bolometer and thus the wave length detection range. Accordingly, a multilayer bolometer structure may be prepared with each thin film layer having a certain critical temperature as defined by the layer thickness, thereby providing broad wavelength detection capabilities. The multilayer bolometer may be prepared by ALD with interfacial layers between the thin film superconducting layers. In addition to various thicknesses of the thin film superconducting layers, the layer may be comprised of the different materials and/or prepared at different deposition temperatures.

The foregoing description of embodiments of the present invention have been presented for purposes of illustration and description. It is not intended to be exhaustive or to limit the present invention to the precise form disclosed, and modification and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A method of forming on a substrate a niobium silicide (NbSi) superconducting film having a tunable superconducting critical temperature by performing a plurality of atomic layer deposition (ALD) cycles within an ALD reactor, the ALD cycle comprising:
establishing a deposition temperature within the ALD reactor;
exposing the substrate within the deposition chamber to a niobium halide precursor;
purging the deposition chamber with an inert purge gas;
exposing the substrate to a reducing precursor to form a monolayer of NbSi over the substrate, the reducing precursor selected from the group consisting of Si₂H₆, SiH₄, and combinations thereof; and
purging the deposition chamber with the inert purge gas,
wherein the superconducting critical temperature is established between about 0.4 K and about 3.1 K by performing a number of the ALD cycles to obtain a predetermined thickness of the NbSi film on the substrate.

2. The method of claim 1, wherein the niobium halide precursor comprises NbF₅.

3. The method of claim 2, wherein the deposition temperatures is selected as between about 150° C. and about 300° C.

4. The method of claim 1, wherein the predetermined thickness is between about 5.2 nm and about 45 nm.

5. The method of claim 1, further comprising forming a seed layer between the substrate and the NbSi film, the seed layer comprising a transition metal and substantially free of oxygen.

6. The method of claim 4, wherein the substrate comprises a high aspect ratio substrate material.

7. The method of claim 1, further comprising annealing the superconducting film at an elevated annealing temperature.

8. A method of preparing a superconducting film having a tunable critical temperature using atomic layer deposition (ALD), comprising:
providing a first metal precursor capable of forming a superconducting film on a substrate, the first metal precursor comprising a first transition metal and a halide;
providing a first reducing precursor, the first reducing precursor comprising silicon and substantially free of oxygen; and
forming at least one superconducting film on the substrate by performing in an ALD reactor a number of ALD cycles at a deposition temperature to obtain the at least one superconducting film comprising the first transition metal and silicon and characterized by a film thickness, each ALD cycle comprises exposing the substrate to the first metal precursor for a first predetermined period, exposing the substrate to the first reducing precursor for a second predetermined period, and purging the ALD reactor after each of the first metal precursor and first reducing precursor exposures,
wherein the superconducting critical temperature of the at least one superconducting film is selectively tunable by modulating the film thickness of the at least one superconducting film.

9. The method of claim 8, wherein the first metal precursor comprises NbF₅.

10. The method of claim 9, wherein the first reducing precursor is selected from the group consisting of: Si₂H₆ and SiH₄.

11. The method of claim 8, wherein the at least one superconducting film consists essentially of niobium silicide (NbSi).

12. The method of claim 8, wherein the film thickness of the at least one superconducting film is between a single monolayer of the film and a critical thickness, wherein the critical thickness is defined by a thickness where the superconducting critical temperature is maximized.

13. The method of claim 8, further comprising forming a seed layer between the substrate and the at least one superconducting film, the seed layer selected from the group consisting of: W, NbC, NbN, NbCN, Mo, MbC, MbN, MbCN, and combinations thereof.

14. The method of claim 8, further comprising annealing the superconducting film at an elevated annealing temperature between about 400° C. and about 600° C., wherein the annealing process is performed in an atmosphere consisting essentially of Ar or N₂.

15. The method of claim 8, further comprising including the superconducting film in a bolometer.

16. The method of claim 8, wherein forming the at least one superconducting film on the substrate comprises forming a plurality of superconducting films on the substrate, the plurality of superconducting films separated by an interfacial layer, and wherein each of the plurality of superconducting films is characterized by a film thickness defining a unique superconducting critical temperature for each of the respective layers.

17. A film prepared by atomic layer deposition (ALD) having a tunable superconducting critical temperature, comprising: a metallic thin film of niobium silicide (NbSi) with a substantially 1:1 stoichiometry characterized by an amorphous structure and a density of about 6.65 g/cm³, the metallic thin film further defined by a substantially uniform film thickness and a superconducting critical temperature selectively tunable between about 0.4 K and about 3.1 K, wherein the superconducting critical temperature is selected by establishing the substantially uniform film thickness between about 5.2 nm and about 45 nm.

18. The film of claim 17, wherein the metallic thin film conformally coats a high aspect ratio substrate.

19. The film of claim 18, further comprising a seed layer film deposed between the high aspect ratio substrate and the metallic thin film, the seed layer film comprising at least one of a metal, a metal carbide, and a metal nitride.

20. The film of claim 17, wherein the metallic thin film defines a portion of a bolometer.
